(19) United States
(12) Patent Application Publication
(10) Pub. No.: US 2007/0203987 A1
(43) Pub. Date: Aug. 30, 2007

(54) System and method for voice-enabled instant messaging

(75) Inventor: Vinh Amis, Phoenix, AZ (US)

Correspondence Address: FULBRIGHT & JAWORSKI L.L.P, 2200 ROSS AVENUE, SUITE 2800, DALLAS, TX, 75201-2784, US

(73) Assignee: Intervoice Limited Partnership, Las Vegas, NV (US)

(21) Appl. No.: 11/361,305

(22) Filed: Feb. 24, 2006

(51) Int. Cl. G06F 15/16

(52) U.S. Cl. 709/206

(57) ABSTRACT

A multi-modal voice-enabling instant message system and method permitting instant messaging to occur either a text format or an audible format with conversion occurring there between. This permits a mobile user to receive instant messaging and reply to instant messaging without having to use a text input keyboard or other visual limitation, thereby allowing the mobile user to continue to use his hands and eyes for critical requirements such as driving.

### CROSS-REFERENCE TO RELATED APPLICATIONS

### Technical Field

This invention relates to an instant messaging system and method for use with mobile communication devices. More particularly, this invention relates to a method and system for multi-modal voice enabled instant messaging for use with mobile communication devices.

### BACKGROUND OF THE INVENTION

Instant text messaging has revolutionized real-time communication between individuals whether operating on personal computers or cell phones having short message service (SMS) capabilities. The use of text messaging via SMS has become very common. However, the SMS channel is not designed for the communication of speech. When an SMS message arrives, the device may produce a unique tone but the user must still read the display screen to obtain the message. SMS transmissions are text messaging which require that the recipient look at the device screen to view the message, thereby diverting their eyes from other critical tasks such as driving. The situation can be aggravated because the user must manipulate one or more keys (or scroll) to read the incoming message. Sometimes the phone cover must be removed or unfolded in order to see the screen or use the keypad. Often, however, the mobile user cannot look at the screen of his/her mobile device for information or to operate keys to obtain the information.

This problem is compounded when the mobile device is used to receive SMS notifications or requests for calendar type appointments. In such a situation, the user must attempt to read the appointment (or other notification) and then respond with an acknowledgement or perhaps suggest an alternate date or time. Again, this requires the use of both the user's eyes and hands which is not always practical when the notification arrives.

Conventional instant messaging (IM) has become the defacto standard for succinct non-verbal real-time communication. Routinely, IM is used when direct contact is unnecessary or undesirable. IM allows for impromptu and immediate communication. However, as noted, it requires access to text entry interfaces such as a computer keyboard and monitor or a PDA or mobile phone keypad and text screen.

In traditional IM each user has the capability of identifying other individuals who are present and available to communicate on an instant basis. Occasionally, such a list is referred to as the “buddy list.” In other words, the user has established a presence. However, when the user signs off from IM services at a personal computer and become mobile s/he is no longer available IM communications.

The current mobile nature of our society oftentimes negates IM as a comprehensive real-time messaging strategy due to the “in-motion” real-time communication limitations. Users who are driving or walking, described here as “in-motion”, may not be in a position to view a text message on a screen, or press keys to send a reply message. Thus, the need exists for an improved system and process to deliver the benefits of instant messaging to “in motion” mobile users.

### SUMMARY OF THE INVENTION

The present invention is directed to a system and method in which instant messages are delivered in either text or audible format between various users. These users may be stationary or mobile and using either text or audible format. In one embodiment the user may create an IM text and transmit that text to an in-motion user. The in-motion user may elect whether to receive the message at that time. If the in-motion user elects to receive the message, the text message is converted to an audible format using text to speech services (TTS). The mobile user would receive the message and elect at that time whether to respond. If such an election to respond is made, the in-motion user may respond with an audible reply. That audible reply is then converted to text using conventional speech to text subsystems services (STT) and transmitted to the original sender using a conventional IM client.

In another embodiment, IM may occur in a voice-to-voice format. One in-motion user may elect to send an instant voice message to an in-motion target, for example. The message is stored until such time as the mobile target elects to receive IM. At that point the stored instant message is delivered. Alternatively, the mobile target may elect to convert the voice instant message to text using STT. The mobile target may then elect to reply in voice or text IM format. If voice format is selected and transmitted, the first user will receive that voice format when s/he signs on subsequently for IM services.

The IM communication system of the present invention comprises means for receiving communications from senders and then translating such communications received either from a text format to an audible format or from an audible format to a text format. The system would also include means for transmitting such translated communications to one or more recipients. The system may also include a detector to determine if the recipients desire to receive the communication in a translated format.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a general schematic illustrating IM communication between two PCs with the option of one user using a mobile communicator.

FIG. 2 is a schematic of the present invention.

FIG. 3 is a schematic of an alternate embodiment of the present invention.

FIG. 4 is a flowchart of a text-to-voice and voice-to-text IM of the present invention.

FIG. 5 is a flowchart of a voice-to-voice embodiment of the present invention.

### DETAILED DESCRIPTION OF THE INVENTION

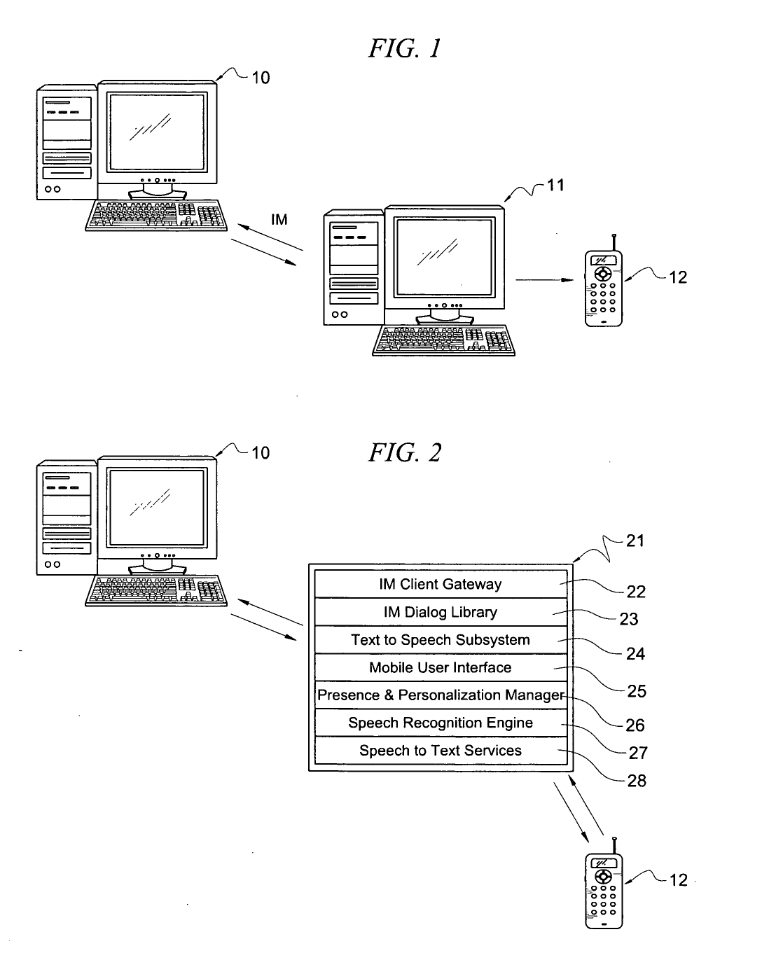

Referring to FIG. 1, two communicators, each on a PC 10, 11, are communicating via IM services. Each is aware of the other since they have identified their presence, typically by logging on to a “buddy list” system. Text messages are being transmitted on an instant basis between each communicator. At some point, the user on PC 11 elects to terminate the conversation and go mobile. Typically, such mobile communication could be achieved via a personal cell phone or a PDA 12,

Referring now to FIG. 2, mobile communicator 12 elects to continue receiving “in motion” IM of the present invention. To achieve this, a multi-modal infrastructure 21 is employed, occasionally referred to as Nexus. Infrastructure 21 is preferably located art a remote location from PC 10 or mobile communicator 12. Thus, infrastructure 21 can accommodate a multitude of PC and mobile users.

Infrastructure 21 comprises an IM Client Gateway 22 which provides integration between telephony and data internet protocol (IP) infrastructures. Such telephony capabilities include SyncML based address book integration with the mobile handset. Adaptors allow for various vendor's IM clients in both proprietary format and from open source clients. Application interfaces include MSN® Messenger; Yahoo® Messenger; AOL's ICQ™ and AIM™ clients; and Google® GMail™ IM. Various IM interoperability options include Extensible Messaging and Presence Protocol (XMPP); SMS; Common Profile for Instant Message (CPIM); SIP for Instant Messaging and Presence Leverage (SIMPLE); and other third party applications such as TRILLIAN™ and JABBER™. These gateways also provide “presence” notification concerning the mobile communicators 12 current IM presence.

Infrastructure 21 also includes IM Dialog Library 23 (IMDL) to increase speech recognition effectiveness. IMDL 23 comprises generally accepted and utilized acronyms within popular media IM context (e.g., IMO for “in my opinion”, BTW for “by the way”). IMDL 23 also provides experienced continuum for multiple user types. Popular acronyms are usually converted via designated grammars, including slangs usages for various age groups.

Referring still to FIG. 2, infrastructure 21 also includes Text to Speech (TTS) subsystem 24, automated speech recognition engine (ASR) 27 and Speech to Text (STT) subsystem 28, commonly available through voice application software providers, such as Nuance. Speech and “natural language” recognition allows users of technology systems to simply “speak” entries as opposed to typing their requests. ASR 27 accepts the spoken IM from the target or operator of mobile communicator 12 and can convert it to a text message as discussed in more detail below, for instant relay or can hold the text message at the direction of the target. ASR 27 would emulate the text instant messaging experience without requiring the use of a text entry interface such as a keyboard. STT 28 captures and digitizes spoken phrases converting them to basic language units or phonemes, constructing words from phonemes, and contextually analyzing the words to ensure correct spelling for words.

Infrastructure 21 also includes a Mobile User Interface 25 which, as described in more detail below, facilitates the interaction between the target or user of mobile communicator 12 and PC 10 through infrastructure 21.

Infrastructure 21 also includes a Mobile IM Presence and Personalization Manger 26 which provides the target or the user of communicator 12 via mobile user Interface 25 with a presence detection capability. The presence detector will notify the operator of PC 10, for example, who is sending an instant message that the current target or user of mobile communicator 12 has “signed on” or “is available only by voice” or some other presence indicator previously selected by the target. In other words, the target or user of mobile communicator 12 selects the current method in which he wishes to receive IM. For example, the operator of mobile communicator 12 may select only to receive IM in text format during normal business hours and voice only during driving/commuting hours.

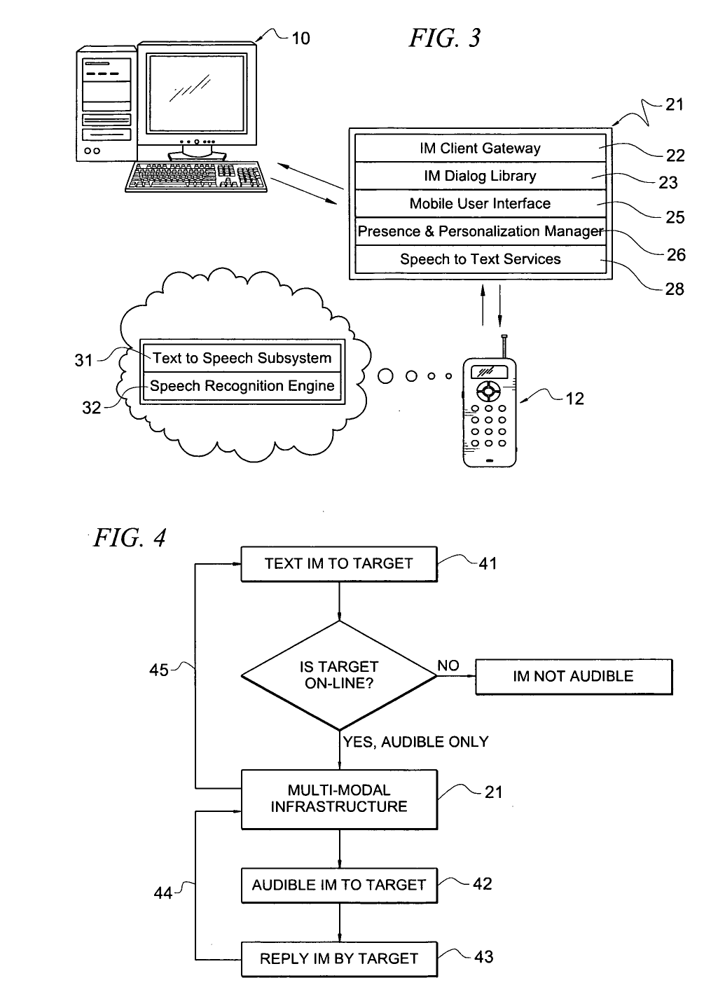

Referring to FIG. 3, an alternate embodiment of FIG. 2 is illustrated. Infrastructure 21 still includes IM Client Gateway 22, IMDL 23, Mobile User Interface 25, Presence and Personalization Manager 26, and STT 28. As mentioned before, Infrastructure 21 is preferably located at a central facility remote from the operator of the PC and the mobile user. However, mobile communicator 12 would include TTS 31 and ASR 32 embedded within the communicator 12. In this manner, the operator of mobile communicator 12 may customize his or her library for particular text to speech conversions and speech recognition.

The present invention provides for IM capabilities which include text-to-voice, voice-to-text, and voice-to-voice. Additionally, the present invention permits the user to receive the delivery of text messaging either with established notifications or speech conversions as discussed in more detail in pending U.S. patent application Ser. No. 11/349,051, entitled “System and Method for Providing Messages to a Mobile Device,” filed Feb. 7, 2006, which is hereby incorporated by reference and made a part of this Application.

Referring to FIG. 4, IM capabilities for transferring text-to-voice to a designated target are illustrated. In this process, the IM center transfers a text message to a designated target through a conventional IM Client Gateway. If the target is on-line in a mobile mode only, infrastructure 21 would receive the IM in accordance with the formats set forth above with respect to FIG. 2. For example, the target may be driving his car and have set his preferences with infrastructure 21 to reflect that he is accepting only audible messages. Under that circumstance, the IM is captured by infrastructure 21 and translated using TTS 24. At that point, infrastructure 21 would inform the target that an audible message is available. The target may elect to receive the audible message at that time or save it until a later time. If he elects to receive it at that time, it would be transmitted as an audible IM 42 to the target.

Referring still to FIG. 4, in the event the target elects to reply to the audible IM, he may do so by speaking his reply 43 into his cell phone or PDA. At that point, reply message 44 is returned to infrastructure 21, converted to a text message by STT 28 at infrastructure 21 and returned 45 to the original sender

As noted above, with respect to FIG. 3, as hand-held cell phones and other PDAs become more capable, it is anticipated that mobile communicator 12 include its own TTS 31 and ASR 32. In that event, the reply 43 sent by the target would not need to pass through a text to speech subsystem which may reside in infrastructure 21. Rather, it may progress directly to the IM Client Gateway 22 for transmission to original sender.

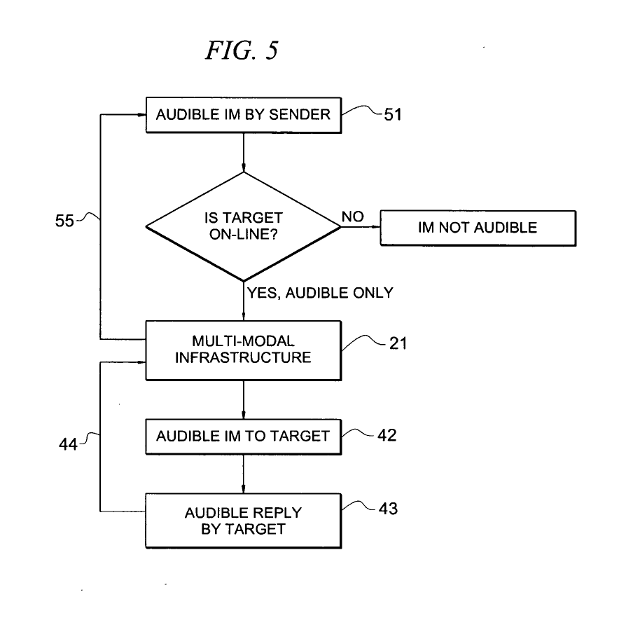

Referring now to FIG. 5, a voice-to-voice embodiment is shown. In this embodiment, the original sender desires to send an audible IM 51 to a designated target. If the target is mobile and available on-line to receive audible only, the message progresses to infrastructure 21. Passing through the IM Client Gateway 22 of Infrastructure 21, and sensing any personalization references 26 established by the target, the audible message progresses to the target 42, where the recipient can listen to the audio message. If the target wishes to reply in an audible format, he may do so, and reply 44 is transmitted back to infrastructure 21. Once again, the audible IM passes through IM Client Gateway 22 of infrastructure 21 and is forwarded back as an audible IM 55 to the original sender. In this embodiment, the original audible message by sender 51 may be at a PC with voice recognition capability. In applying this process, it is anticipated that the original sender would confirm that the target is available on his “buddy list.” The buddy list confirms that the target is available in a mobile mode only, and the original sender then elects to proceed forward with an audible IM.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing instant messaging services between text and audible format comprising the steps of:
creating a first message in either text or audible format at a first sender;
converting the first message from text format to audible format or from audible format to text format based on a signal from a first receiver indicating the desire to receive the first message and the preferred format; and
providing the converted first message to the first receiver.

2. The method according to claim 1 wherein said method further comprises the steps of:
creating a second message in either text or audible format at said first receiver;
converting the second message from audible format to text format or from text format to audible format; and
providing the converted second message to said first sender.

3. The method according to claim 1 further comprising the step of:
prior to converting the first message, determining if the first receiver desires to receive the first converted message.

4. The method according to claim 2 wherein said method further comprises the step of:
prior to converting the second message, determining if the first transmitter desires to receive the second converted message.

5. A method of providing instant messaging services between text and audible format comprising the steps of:
creating a first message in either text or audible format at a first transmitter for a first receiver;
determining if the first receiver desires to receive the first message converted from text format to audible format or from audible format to text format;
converting the first message from text format to audible format or from audible format to text format;
providing the converted first message to the first receiver;
creating a second message in either text or audible format at the first receiver;
determining if the first transmitter desires to receive the second message converted from audible format to text format or from text format to audible format;
converting the second message from audible format to text format or from text format to audible format; and
providing the converted second message to the first transmitter.

6. An instant messaging communication system comprising:
means for receiving communications from senders;
means for translating communications received from a text format to an audible format based on the predetermined desires of receivers of said communications; and
means for transmitting said translated communications to recipients.

7. The system according to claim 6 further comprising:
second means for translating communications received from an audible format to a text format based on the predetermined desires or receivers;

8. The system according to claim 6 further comprising:
a detector to determine if recipients desire to receive communications in a translated format.

9. The system according to claim 6 wherein said receiving means comprises a gateway of instant messaging communications.

10. The system according to claim 6 wherein said first translating means comprises a text-to-speech subsystem.

11. The system according to claim 7 wherein said second translating means comprises a speech-to-text subsystem.

12. An instant messaging communication system comprising:
a gateway providing access to instant messaging users;
at least one text-to-speech subsystem for translating communications received in text format from a sending instant messaging user to an alternate format desirable to a receiving instant messaging user who desires for a period of time, to receive instant messaging in an alternate format; and
means for delivering said translated received instant message to said receiving instant messaging user.

13. The instant messaging communication system of claim 12 further comprising:
a library of commonly used text terms.

14. The instant messaging communication system of claim 12 further comprising:
means for detecting the presence of users.

15. The instant messaging communication system of claim 12 further comprising;
means for personalizing the desires of users.

16. A system for enabling instant messaging, said instant messaging being characterized as a text message sent from a sending user to a target user during periods of time when said target user has signaled availability to receive instant messaging, said system comprising:
a converter for changing an instant text message addressed to a target user who has signaled availability to receive instant text messages to an alternate format during periods of time when said target user has signaled a temporary unavailability to receive instant text messages.

17. The system of claim 16 further comprising:
means for delivering said converted message to said target user.

18. The system of claim 17 further comprising:
second means for delivering non-text instant messages received from said target user in a text format.

19. The system of claim 18 further comprising:
means for inhibiting said second delivery means when said sending user is unavailable to receive text messages.
